(19) United States
(12) Patent Application Publication
(10) Pub. No.: US 2019/0211129 A1
(43) Pub. Date: Jul. 11, 2019

(54) FLUORINATED THERMOPLASTIC ELASTOMER

(71) Applicant: SOLVAY SPECIALTY POLYMERS ITALY S.P.A., Bollate (IT)

(72) Inventors: Marco DOSSI, Milano (IT); Marco AVATANEO, Milano (IT); Matteo FANTONI, Vanzaghello (IT); Bradley Lane KENT, Woolwich Township, NJ (US); Martina CORASANITI, Caronno Pertusella (IT); Satchit SRINIVASAN, Dallas, TX (US)

(21) Appl. No.: 16/333,935

(22) PCT Filed: Sep. 13, 2017
(86) PCT No.: PCT/EP2017/073008

§ 371 Date: Mar. 15, 2019

Related U.S. Application Data
(60) Provisional application No. 62/395,766, filed on Sep. 16, 2016.

(30) Foreign Application Priority Data
Mar. 9, 2017 (EP) 17160111.5

(51) Int. Cl. C08F 293/00

(52) U.S. Cl. CPC C08F 293/00; C08F 2438/00; C08F 2800/10

(57) ABSTRACT

The present invention pertains to a fluorinated thermoplastic elastomer, to a process for the manufacture of said fluorinated thermoplastic elastomer and to uses of said fluorinated thermoplastic elastomer in various applications, especially in low temperature applications.

### CROSS-REFERENCE TO RELATED APPLICATIONS

This application claims priority to U.S. provisional application No. 62/395,766 filed on Sep. 16, 2016 and to European application No. 17160111.5 filed on Mar. 9, 2017, the whole content of each of these applications being incorporated herein by reference for all purposes.

### TECHNICAL FIELD

The present invention pertains to a fluorinated thermoplastic elastomer, to a process for the manufacture of said fluorinated thermoplastic elastomer and to uses of said fluorinated thermoplastic elastomer in various applications, especially in low temperature applications.

### BACKGROUND ART

Fluorinated thermoplastic elastomers are known in the art.

As known, thermoplastic elastomers are block copolymers consisting of at least one “soft” segment having elastomeric properties and at least one “hard” segment having thermoplastic properties.

In particular, fluorinated thermoplastic elastomers having improved mechanical and elastic properties by the introduction in the polymeric chain of small amounts of a bis-olefin are described, for instance, in U.S. Pat. No. 5,612,419 (AUSIMONT S.P.A.) 18 Mar. 1997.

Also, fluorinated thermoplastic elastomers having improved mechanical and elastic properties by the introduction in the polymeric chain of small amounts of an iodinated olefin are described, for instance, in U.S. Pat. No. 5,605,971 (AUSIMONT S.P.A.) 25 Feb. 1997.

All working embodiments exemplified in the documents above are representative of fluorinated thermoplastic elastomers whereas the soft/elastomeric block is a block comprising tetrafluoroethylene recurring units.

Additional fluorinated thermoplastic elastomers are disclosed in EP 1029875 A23.08.2000, whereas a multi-segment polymer having an elastomeric fluorine-containing polymer chain segment, and a non-elastomeric fluorine-containing polymer chain, in which said elastomeric fluorine-containing polymer chain segment has perhaloolefin units as recurring unit, and more specifically has tetrafluoroethylene as recurring unit.

However, the fluorinated thermoplastic elastomers of the prior art disadvantageously suffer from poor sealing properties at low temperatures.

There is thus still the need in the art for fluorinated thermoplastic elastomers able to withstand very low temperatures while successfully preserving their elastomeric properties.

### SUMMARY OF INVENTION

It has been now surprisingly found that the fluorinated thermoplastic elastomers of the present invention advantageously exhibit outstanding performances such as outstanding mechanical performances over a wide range of temperatures up to low temperatures, in combination with excellent chemical resistance, UV resistance and weatherability, to be suitably used in various applications such as, for instance, low temperature applications.

In a first instance, the present invention pertains to a fluorinated thermoplastic elastomer comprising, preferably consisting of:
at least one block (A) consisting of at least one elastomeric fluoropolymer substantially free from recurring units derived from tetrafluoroethylene (TFE), and
at least one block (B) consisting of at least one thermoplastic fluoropolymer comprising:
recurring units derived from vinylidene fluoride (VDF), and
optionally, recurring units derived from at least one fluorinated monomer different from VDF.

The fluorinated thermoplastic elastomer of the invention is advantageously a block copolymer, said block copolymer typically having a structure comprising at least one block (A) alternated to at least one block (B), that is to say that said fluorinated thermoplastic elastomer typically comprises, preferably consists of, one or more repeating structures of type B-A-B.

The block (A) is typically named as soft block (A).

The block (B) is typically named as hard block (B).

For the purpose of the present invention, the term “elastomeric” is hereby intended to denote a fluoropolymer having a heat of fusion of less than 5 J/g, preferably of less than 3 J/g, more preferably of less than 2 J/g, as measured according to ASTM D3418-08.

The elastomeric fluoropolymer is typically a fluoropolymer resin serving as base constituent for obtaining a true elastomer, said fluoropolymer resin comprising more than 10% by weight, preferably more than 30% by weight of recurring units derived from at least one fluorinated monomer.

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

For the purpose of the present invention, the term “thermoplastic” is hereby intended to denote a fluoropolymer existing, at room temperature (25° C.), below its melting point if it is semi-crystalline, or below its glass transition temperature (T_{g}) if it is amorphous. These polymers have the property of becoming soft when they are heated and of becoming rigid again when they are cooled, without there being an appreciable chemical change. Such a definition may be found, for example, in the encyclopaedia called “Polymer Science Dictionary”, Mark S. M. Alger, London School of Polymer Technology, Polytechnic of North London, UK, published by Elsevier Applied Science, 1989.

The thermoplastic fluoropolymer typically has a heat of fusion of from 10 J/g to 90 J/g, preferably of from 30 J/g to 60 J/g, more preferably of from 35 J/g to 55 J/g, as measured according to ASTM D3418-08.

The crystallinity of said block (B) and its weight fraction in the fluorinated thermoplastic elastomer are such to provide for a heat of fusion of the fluorinated thermoplastic elastomer of at least 5 J/g, preferably at least 7 J/g, and preferably of at most 20 J/g, more preferably at most 15 J/g, when determined according to ASTM D3418-08.

For the purpose of the present invention, the term “fluoropolymer” is hereby intended to denote a polymer comprising recurring units derived from at least one fluorinated monomer.

The term “fluorinated monomer” is hereby intended to denote an ethylenically unsaturated monomer comprising at least one fluorine atom.

The fluorinated monomer may further comprise one or more other halogen atoms (Cl, Br, I).

The fluoropolymer may further comprise recurring units derived from at least one hydrogenated monomer.

The term “hydrogenated monomer” is hereby intended to denote an ethylenically unsaturated monomer comprising at least one hydrogen atom and free from fluorine atoms.

The block (A) preferably consists of at least one elastomeric fluoropolymer consisting of:
recurring units derived from vinylidene fluoride (VDF),
recurring units derived from at least one fluorinated monomer different from VDF and tetrafluoroethylene (TFE), and
optionally, recurring units derived from at least one hydrogenated monomer.

The elastomeric fluoropolymer preferably consists of:
recurring units derived from vinylidene fluoride (VDF),
recurring units derived from at least one fluorinated monomer different from VDF and tetrafluoroethylene (TFE), and
optionally, recurring units derived from at least one hydrogenated monomer,

wherein the fluorinated monomer is selected from the group consisting of:

(a) C₃-C₈ perfluoroolefins such as hexafluoropropylene (HFP) and hexafluoroisobutylene;

(b) hydrogen-containing C₂-C₈ fluoroolefins such as vinyl fluoride, trifluoroethylene (TrFE), perfluoroalkyl ethylenes of formula CH₂═CH—R_{f1}, wherein R_{f1} is a C₁-C₆ perfluoroalkyl group;

(c) C₂-C₈ chloro- and/or bromo-fluoroolefins such as chlorotrifluoroethylene (CTFE);

(d) (per)fluoroalkylvinylethers (PAVE) of formula CF₂═CFOR_{f2}, wherein R_{f2} is a C₁-C₆ (per)fluoroalkyl group, such as CF₃ (PMVE), C₂F₅ or C₃F₇;

(e) (per)fluorooxyalkylvinylethers of formula CF₂═CFOX₀, wherein X₀ is a C₁-C₁₂ oxyalkyl group or a C₁-C₁₂ (per)fluorooxyalkyl group comprising one or more ether oxygen atoms, such as perfluoro-2-propoxypropyl group; and

(f) (per)fluorodioxoles of formula:

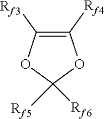

wherein each of R_{f3}, R_{f4}, R_{f5} and R_{f6}, equal to or different from each other, is independently a fluorine atom, a C₁-C₆ fluoro- or per(halo)fluoroalkyl group, optionally comprising one or more oxygen atoms, such as —CF₃, —C₂F₅, —C₃F₇, —OCF₃ or —OCF₂CF₂OCF₃.

The elastomeric fluoropolymer may further comprise recurring units derived from at least one hydrogenated monomer selected from the group consisting of C₂-C₈ non-fluorinated olefins such as ethylene, propylene or isobutylene.

The elastomeric fluoropolymer more preferably consists of:
from 45% to 90% by moles of recurring units derived from vinylidene fluoride (VDF),
from 5% to 50% by moles of recurring units derived from at least one fluorinated monomer different from VDF and tetrafluoroethylene (TFE), and
optionally, up to 30% by moles of recurring units derived from at least one hydrogenated monomer.

The elastomeric fluoropolymer may further comprise recurring units derived from at least one bis-olefin [bis-olefin (OF)] of formula:

R_{A}R_{B}═CR_{C}-T-CR_{D}═R_{E}R_{F}

wherein R_{A}, R_{B}, R_{C}, R_{D}, R_{E} and R_{F}, equal to or different from each other, are selected from the group consisting of H, F, Cl, C₁-C₅ alkyl groups and C₁-C₅ (per)fluoroalkyl groups, and T is a linear or branched C₁-C₁₈ alkylene or cycloalkylene group, optionally comprising one or more ether oxygen atoms, preferably at least partially fluorinated, or a (per)fluoropolyoxyalkylene group.

The bis-olefin (OF) is preferably selected from the group consisting of those of any of formulae (OF-1), (OF-2) and (OF-3):

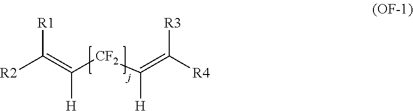

wherein j is an integer comprised between 2 and 10, preferably between 4 and 8, and R1, R2, R3 and R4, equal to or different from each other, are selected from the group consisting of H, F, C₁-C₅ alkyl groups and C₁-C₅ (per)fluoroalkyl groups;

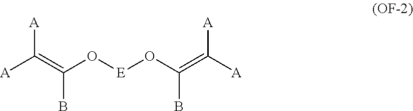

wherein each of A, equal to or different from each other and at each occurrence, is independently selected from the group consisting of H, F and Cl; each of B, equal to or different from each other and at each occurrence, is independently selected from the group consisting of H, F, Cl and OR_{B}, wherein R_{B} is a branched or straight chain alkyl group which may be partially, substantially or completely fluorinated or chlorinated, E is a divalent group having 2 to 10 carbon atoms, optionally fluorinated, which may be inserted with ether linkages; preferably E is a —(CF₂)ₘ— group, wherein m is an integer comprised between 3 and 5; a preferred bis-olefin of (OF-2) type is F₂C═CF—O—(CF₂)₅—O—CF═CF₂;

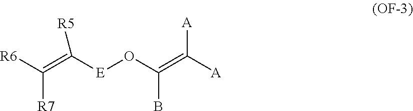

wherein E, A and B have the same meaning as defined above, R5, R6 and R7, equal to or different from each other, are selected from the group consisting of H, F, C₁-C₅ alkyl groups and C₁-C₅ (per)fluoroalkyl groups.

The elastomeric fluoropolymer typically further comprises recurring units derived from at least one bis-olefin (OF) in an amount comprised between 0.01% and 1.0% by moles, preferably between 0.03% and 0.5% by moles, more preferably between 0.05% and 0.2% by moles, based on the total moles of recurring units constituting said elastomeric fluoropolymer.

The skilled in the art will understand that, irrespective of the amount of recurring units derived from at least one bis-olefin (0-F) in the elastomeric fluoropolymer, if any, the inherent properties of the fluorinated thermoplastic elastomer will remain unchanged.

The elastomeric fluoropolymer may also further comprise recurring units derived from at least one halogenated olefin [olefin (H)].

The halogenated olefin [olefin (H)] is typically of formula:

CX₂═CX—R_{f}—CHY—K

wherein X is H, F or —CH₃, Y is H or —CH₃, R_{f} is a linear or branched (per)fluoroalkylene group, optionally comprising one or more ether oxygen atoms, or a (per)fluoropolyoxyalkylene group, and K is iodine (I) or bromine (Br).

The olefin (H) is typically selected from the group consisting of iodinated olefins [olefins (I)], wherein K is iodine (I), and brominated olefins [olefins (Br)], wherein K is bromine (Br).

The olefin (H) is typically selected from the group consisting of those of any of formulae (H-1) and (H-2):

CHY═CH—Z—CH₂CHY—K (H-1)

wherein Y is H or —CH₃, Z is a linear or branched C₁-C₁₈ (per)fluoroalkylene group, optionally comprising one or more ether oxygen atoms, or a (per)fluoropolyoxyalkylene group, and K is iodine (I) or bromine (Br); and

CF₂═CF—O—(CF₂CFWO)ₙ—(CF₂CF₂CH₂O)ₘ—CF₂CF₂CH₂K (H-2)

wherein W is —F or —CF₃, K is iodine (I) or bromine (Br), m is an integer from 0 to 5, and n is 0, 1 or 2.

As regards the olefin (H) of formula (H-1), Z is preferably a C₄-C₁₂ perfluoroalkylene group, or a (per)fluoropolyoxyalkylene group of formula:

-(Q)ₚ-CF₂O—(CF₂CF₂O)ₘ(CF₂O)ₙ—CF₂-(Q)ₚ-

wherein Q is a C₁-C₆, preferably a C₁-C₃, alkylene or oxyalkylene group, p is 0 or 1, m and n are numbers such that the m/n ratio is from 0.2 to 5 and the molecular weight of said (per)fluoropolyoxyalkylene group is from 400 to 10000, preferably from 500 to 1000. Q is preferably selected from the group consisting of —CH₂O—, —CH₂OCH₂—, —CH₂— and —CH₂CH₂—.

The olefin (H) of formula (H-1) can be prepared starting from the compounds of formula K—Z—K according to the following process:

(i) adding ethylene or propylene to a compound of formula K—Z—K thereby providing a di-halogenated product of formula:

K—CHY—CH₂—Z—CH₂—CHY—K

wherein Y, Z and K are defined as above; and

(ii) partially dehydrohalogenating the di-halogenated product provided in step (i) with a base (for instance NaOH, KOH or a tertiary amine).

Under step (i), the addition of ethylene or propylene is usually carried out in the presence of suitable catalysts, such as redox systems, for instance CuI or FeCl₃, typically in solution in an organic solvent, for instance acetonitrile. The addition reaction between a perfluoroalkyl iodide and an olefin is described, for instance, by M. Hudliky in “Chemistry of Organic Fluorine Compounds” (2nd Edition, Ellis Horwood Ltd., Chichester, 1976), and by R. E. Banks in “Organofluorine Chemicals and Their Industrial Applications” (Ellis Horwood Ltd, Chichester, 1979), or in J. Fluorine Chemistry, 49 (1990), 1-20, and in J. Fluorine Chemistry, 58 (1992), 1-8.

The dehydrohalogenation reaction of step (ii) can be carried out either in the absence of a solvent or by dissolving the di-halogenated product in a suitable solvent such as, for instance, a glycol such as diethylenglycol, or a long chain alcohol. To maximize the yield of the olefin (H), while avoiding as far as possible a further dehydrohalogenation reaction with formation of the corresponding bis-olefin of formula CHY═CH—Z—CH═CHY, it is possible:

(1) to use the base in non-stoichiometric amounts, with a molar ratio base/di-halogenated product preferably from 1.5 to 0.5, and then separate the olefin (H) from the bis-olefin by fractional distillation; or

(2) to carry out the dehydrohalogenation reaction at reduced pressure so as to remove the olefin (H) from the reaction mixture as it forms, taking advantage of the fact that the latter has a boiling point lower than that of the starting di-halogenated product; in such case the reaction is preferably carried out without any solvent.

Alternatively, it is possible to carry out step (i) in deficient amounts of ethylene or propylene, to favour as much as possible the formation of mono-addition product K—Z—CH₂—CHY—K (which can be separated from the di-addition product by fractional distillation); the mono-addition product is then dehydrohalogenated as described above, with formation of the olefin K—Z—CH═CHY, which is finally subjected to a further addition of ethylene or propylene to give the olefin (H) of formula (H-1).

When Z is a (per)fluoroalkylene group, optionally comprising one or more ether oxygen atoms, the starting di-halogenated product K—Z—K can be obtained by telomerization of a C₂-C₄ (per)fluoroolefin or of a C₃-C₈, (per)fluorovinylether (for instance tetrafluoroethylene, perfluoropropylene, vinylidene fluoride, perfluoromethylvinylether, perfluoropropylvinylether, or mixtures thereof), using a product of formula K—(R′_{f})ₖ—K, wherein k is 0 or 1, R′_{f} is a C₁-C₈ (per)fluoroalkylene group, and K is iodine (I) or bromine (Br), as telogenic agent. Telomerization reactions of this type are described, for instance, by C. Tonelli and V. Tortelli in J. Fluorine Chem., 47 (1990), 199, or also in EP 200908 A (AUSIMONT S.P.A.) 17 Dec. 1986. When Z is a (per)fluoropolyoxyalkylene group, the preparation of the products I-Z-I is described, for instance, in U.S. Pat. No. 3,810,874 (MINNESOTA MINING AND MANUFACTURING CO.) 14 May 1974.

The olefin (I) of formula (H-2) and the preparation process thereof are described, for instance, in EP 199138 A (DAIKIN INDUSTRIES, LTD.) 29 Oct. 1986, which is herein incorporated by reference.

Non-limiting examples of olefins (I) of formula (H-2) include the followings: CF₂═CF—OCF₂CF₂CH₂I and CF₂═CF—OCF₂CF(CF₃)OCF₂CF₂CH₂I.

Should the elastomeric fluoropolymer further comprise recurring units derived from at least one olefin (H), said elastomeric fluoropolymer typically further comprises recurring units derived from at least one olefin (H) in an amount comprised between 0.01% and 1.0% by moles, preferably between 0.03% and 0.5% by moles, more preferably between 0.05% and 0.2% by moles, based on the total moles of recurring units constituting said elastomeric fluoropolymer.

The skilled in the art will understand that, irrespective of the amount of recurring units derived from at least one olefin (H) in the elastomeric fluoropolymer, if any, the inherent properties of the fluorinated thermoplastic elastomer will remain unchanged.

Among specific compositions of elastomeric fluoropolymers suitable for the purpose of the invention, mention can be made of the following compositions (% by moles):

(I) vinylidene fluoride (VDF) 45-85%, hexafluoropropylene (HFP) 15-45%, bis-olefin (O-F) 0-0.30%;

(II) vinylidene fluoride (VDF) 50-80%, perfluoroalkyl vinyl ethers (PAVE) 5-50%; and

(III) vinylidene fluoride (VDF) 20-30%, hexafluoropropylene (HFP) and/or perfluoroalkyl vinyl ethers (PAVE) 18-27%, C₂-C₈ non-fluorinated olefins 10-30%.

The block (B) preferably consists of at least one thermoplastic fluoropolymer comprising:
recurring units derived from vinylidene fluoride (VDF), and
optionally, from 0.1% to 10% by moles of recurring units derived from at least one fluorinated monomer different from VDF.

The thermoplastic fluoropolymer may further comprise recurring units derived from at least one hydrogenated monomer.

The thermoplastic fluoropolymer preferably comprises, more preferably consists of:
recurring units derived from vinylidene fluoride (VDF),
optionally, from 0.1% to 10% by moles of recurring units derived from at least one fluorinated monomer different from VDF, and
optionally, recurring units derived from at least one hydrogenated monomer,

wherein the fluorinated monomer is selected from the group consisting of:

(a′) C₂-C₈ perfluoroolefins such as tetrafluoroethylene (TFE) and hexafluoropropylene (HFP);

(b′) C₂-C₈ hydrogenated fluoroolefins such as vinyl fluoride, 1,2-difluoroethylene and trifluoroethylene;

(c′) perfluoroalkylethylenes of formula CH₂═CH—R_{f0}, wherein R_{f0} is a C₁-C₆ perfluoroalkyl group;

(d′) chloro- and/or bromo- and/or iodo-C₂-C₆ fluoroolefins such as chlorotrifluoroethylene;

(e′) (per)fluoroalkylvinylethers of formula CF₂═CFOR_{f1}, wherein R_{f1} is a C₁-C₆ fluoro- or perfluoroalkyl group, e.g. CF₃, C₂F₅, C₃F₇;

(f′) CF₂═CFOX₀ (per)fluoro-oxyalkylvinylethers, wherein X₀ is a C₁-C₁₂ alkyl group, a C₁-C₁₂ oxyalkyl group or a C₁-C₁₂ (per)fluorooxyalkyl group having one or more ether groups, such as perfluoro-2-propoxy-propyl group;

(g′) (per)fluoroalkylvinylethers of formula CF₂═CFOCF₂OR_{f2},wherein R_{f2} is a C₁-C₆ fluoro- or perfluoroalkyl group, e.g. CF₃, C₂F₅, C₃F₇ or a C₁-C₆ (per)fluorooxyalkyl group having one or more ether groups such as —C₂F₅—O—CF₃;

(h′) functional (per)fluoro-oxyalkylvinylethers of formula CF₂═CFOY₀, wherein Y₀ is a C₁-C₁₂ alkyl group or (per)fluoroalkyl group, a C₁-C₁₂ oxyalkyl group or a C₁-C₁₂ (per)fluorooxyalkyl group having one or more ether groups and Y₀ comprising a carboxylic or sulfonic acid group, in its acid, acid halide or salt form; and

(i′) fluorodioxoles, preferably perfluorodioxoles.

The weight ratio between blocks (A) and blocks (B) in the fluorinated thermoplastic elastomer of the invention is typically comprised between 5:95 and 95:5, preferably between 10:90 and 90:10, more preferably between 20:80 and 80:20, even more preferably between 60:40 and 40:60.

The fluorinated thermoplastic elastomer of the invention typically has a glass transition temperature (T_{g}) below room temperature. In most cases, the fluorinated thermoplastic elastomer of the invention has advantageously a T_{g} below −10° C., preferably below −15° C., more preferably below −20° C.

In a second instance, the present invention pertains to a process for the manufacture of a fluorinated thermoplastic elastomer, said process comprising the following sequential steps:

(a) polymerizing at least one fluorinated monomer different from tetrafluoroethylene (TFE) and, optionally, at least one hydrogenated monomer, in the presence of a radical initiator and of an iodinated chain transfer agent, thereby providing a pre-polymer consisting of at least one block (A) containing one or more iodinated end groups; and

(b) polymerizing vinylidene fluoride (VDF), optionally, at least one fluorinated monomer different from VDF and, optionally, at least one hydrogenated monomer, in the presence of a radical initiator and of the pre-polymer provided in step (a), thereby providing at least one block (B) grafted on said pre-polymer by means of the iodinated end groups.

The fluorinated thermoplastic elastomer of the invention is advantageously obtainable by the process of the invention.

The block (A) provided in step (a) of the process of the invention is the same as defined hereinabove.

The block (B) provided in step (b) of the process of the invention is the same as defined hereinabove.

The process of the invention is preferably carried out in aqueous emulsion polymerization according to methods well known in the art, in the presence of a suitable radical initiator.

The radical initiator is typically selected from the group consisting of:
inorganic peroxides such as, for instance, alkali metal or ammonium persulphates, perphosphates, perborates or percarbonates, optionally in combination with ferrous, cuprous or silver salts or other easily oxidable metals;
organic peroxides such as, for instance, disuccinylperoxide, tertbutyl-hydroperoxide, and ditertbutylperoxide; and
azo compounds (see, for instance, U.S. Pat. No. 2,515,628 (E. I. DU PONT DE NEMOURS AND CO.) 18 Jul. 1950 and U.S. Pat. No. 2,520,338 (E. I. DU PONT DE NEMOURS AND CO.) 29 Aug. 1950).

It is also possible to use organic or inorganic redox systems, such as persulphate ammonium/sodium sulphite, hydrogen peroxide/aminoiminomethansulphinic acid.

Under step (a) of the process of the invention, one or more iodinated chain transfer agents are added to the reaction medium, typically of formula RₓIₙ, wherein Rₓ is a C₁-C₁₆, preferably a C₁-C₈ (per)fluoroalkyl or a (per)fluorochloroalkyl group, and n is 1 or 2. It is also possible to use as chain transfer agents alkali or alkaline-earth metal iodides, as described in U.S. Pat. No. 5,173,553 (AUSIMONT S.P.A.) 22 Dec. 1992. The amount of the chain transfer agent to be added is established depending on the molecular weight which is intended to be obtained and on the effectiveness of the chain transfer agent itself.

Under any of steps (a) and (b) of the process of the invention, one or more surfactants may be used, preferably fluorinated surfactants of formula:

R_{y}—X⁻M⁺

wherein R_{y} is a C₅-C₁₆ (per)fluoroalkyl or a (per)fluoropolyoxyalkyl group, X⁻ is —COO⁻ or —SO₃⁻, and M⁺ is selected from the group consisting of H⁺, NH₄⁺, and an alkali metal ion.

Among the most commonly used surfactants, mention can be made of (per)fluoropolyoxyalkylenes terminated with one or more carboxyl groups.

When step (a) is terminated, the reaction is discontinued, for instance by cooling, and the residual monomers are removed, for instance by heating the emulsion under stirring.

The second polymerization step (b) is then carried out, feeding the new monomer mixture and adding fresh radical initiator.

If necessary, under step (b) of the process of the invention, one or more further chain transfer agents may be added, which can be selected from the same iodinated chain transfer agents as defined above or from chain transfer agents known in the art for use in the manufacture of fluoropolymers such as, for instance, ketones, esters or aliphatic alcohols having from 3 to 10 carbon atoms, such as acetone, ethylacetate, diethylmalonate, diethylether and isopropyl alcohol; hydrocarbons, such as methane, ethane and butane; chloro(fluoro)carbons, optionally containing hydrogen atoms, such as chloroform and trichlorofluoromethane; bis(alkyl)carbonates wherein the alkyl group has from 1 to 5 carbon atoms, such as bis(ethyl) carbonate and bis(isobutyl) carbonate.

When the process is terminated, the fluorinated thermoplastic elastomer is isolated from the emulsion according to conventional methods, such as by coagulation by addition of electrolytes or by cooling.

Alternatively, the polymerization reaction can be carried out in mass or in suspension, in an organic liquid where a suitable radical initiator is present, according to known techniques. The polymerization temperature and pressure can vary within wide ranges depending on the type of monomers used and based on the other reaction conditions.

The process of invention is typically carried out at a temperature of from −20° C. to 150° C.

The process of invention is typically carried out under pressures up to 10 MPa.

The process of the invention is preferably carried out in aqueous emulsion polymerization in the presence of a microemulsion of perfluoropolyoxyalkylenes, as described in U.S. Pat. No. 4,864,006 (AUSIMONT S.P.A.) 5 Sep. 1989, or in the presence of a microemulsion of fluoropolyoxyalkylenes having hydrogenated end groups and/or hydrogenated recurring units, as described in EP 625526 A (AUSIMONT S.P.A.) 23 Nov. 1994.

In a third instance, the present invention pertains to a composition [composition (C)] comprising:
at least one fluorinated thermoplastic elastomer according to the invention, and
optionally, one or more additives.

In a fourth instance, the present invention pertains to an article comprising the composition (C) of the invention.

Non-limiting examples of additives suitable for use in the composition (C) of the invention include, notably, fillers such as carbon black, silica, stabilizers, antioxidants, pigments, thickeners and plasticizers.

The composition (C) of the invention typically comprises one or more additives in an amount of from 0.5 to 40 phr, preferably from 1 to 20 phr.

The article of the invention is advantageously obtainable by processing the composition (C) of the invention typically using melt-processing techniques such as compression moulding, injection moulding and extrusion moulding.

According to an embodiment of the invention, the composition (C) of the invention may be advantageously used as processing aid in a process for the manufacture of an article comprising at least one polymer.

According to this embodiment of the invention, the article of the invention is obtainable by processing a composition comprising at least one polymer, in the presence of the composition (C) of the invention, typically using melt-processing techniques such as compression moulding, injection moulding and extrusion moulding.

It has been found that the article so obtained advantageously exhibits outstanding mechanical properties.

No subsequent post-treatment or post-cure step is typically required after processing of the composition (C) of the invention into an article.

In a fifth instance, the present invention pertains to use of the article of the invention in various applications such as low temperature applications.

The article of the invention is particularly suitable for use in various applications such as automotive (e.g. fuel hose, gasket, sealing), chemical process industry and oil and gas applications.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

### EXAMPLE 1: BLOCK COPOLYMER HAVING STRUCTURE PVDF-P(VDF-HFP)-PVDF (P(VDF-HFP) VDF: 78.5% BY MOLES, HFP: 21.5% BY MOLES)

In a 7.5 liters reactor equipped with a mechanical stirrer operating at 72 rpm, 4.5 l of demineralized water and 22 ml of a microemulsion, previously obtained by mixing 4.8 ml of a perfluoropolyoxyalkylene having acidic end groups of formula CF₂ClO(CF₂—CF(CF₃)O)ₙ(CF₂O)ₘCF₂COOH, wherein n/m=10, having an average molecular weight of 600, 3.1 ml of a 30% v/v NH₄OH aqueous solution, 11.0 ml of demineralized water and 3.0 ml of GALDEN® D02 perfluoropolyether of formula CF₃O(CF₂CF(CF₃)O)ₙ(CF₂O)ₘCF₃, wherein n/m=20, having an average molecular weight of 450, were introduced.

The reactor was heated and maintained at a set-point temperature of 85° C.; a mixture of vinylidene fluoride (VDF) (78.5% moles) and hexafluoropropylene (HFP) (21.5% moles) was then added to reach a final pressure of 20 bar. Then, 8 g of 1,4-diiodoperfluorobutane (C₄F₈I₂) as chain transfer agent were introduced, and 1.25 g of ammonium persulfate (APS) as initiator were introduced. Pressure was maintained at a set-point of 20 bar by continuous feeding of a gaseous mixture of vinylidene fluoride (VDF) (78.5% by moles) and hexafluoropropylene (HFP) (21.5% by moles) up to a total of 2000 g. Moreover, 0.86 g of CH₂═CH—(CF₂)₆—CH═CH₂, fed in 20 equivalent portions each 5% increase in conversion, were introduced.

Once 2000 g of monomer mixture were fed to the reactor, the reaction was discontinued by cooling the reactor to room temperature. The residual pressure was then discharged and the temperature brought to 80° C. VDF was then fed into the autoclave up to a pressure of 20 bar, and 0.14 g of ammonium persulfate (APS) as initiator were introduced. Pressure was maintained at a set-point of 20 bar by continuous feeding of VDF up to a total of 500 g. Then, the reactor was cooled, vented and the latex recovered. The latex was treated with aluminum sulphate, separated from the aqueous phase, washed with demineralized water and dried in a convection oven at 90° C. for 16 hours.

Characterization data of the polymer so obtained are reported in Table 1.

### COMPARATIVE EXAMPLE 1: P(VDF-HFP) FLUOROELASTOMER (VDF: 78.5% BY MOLES, HFP: 21.5% BY MOLES)

In a 7.5 liters reactor equipped with a mechanical stirrer operating at 72 rpm, 4.5 l of demineralized water and 22 ml of a microemulsion, previously obtained by mixing 4.8 ml of a perfluoropolyoxyalkylene having acidic end groups of formula CF₂ClO(CF₂—CF(CF₃)O)ₙ(CF₂O)ₘCF₂COOH, wherein n/m=10, having an average molecular weight of 600, 3.1 ml of a 30% v/v NH₄OH aqueous solution, 11.0 ml of demineralized water and 3.0 ml of GALDEN® D02 perfluoropolyether of formula CF₃O(CF₂CF(CF₃)O)ₙ(CF₂O)ₘCF₃, wherein n/m=20, having an average molecular weight of 450, were introduced.

The reactor was heated and maintained at a set-point temperature of 85° C.; a mixture of vinylidene fluoride (VDF) (78.5% moles) and hexafluoropropylene (HFP) (21.5% moles) was then added to reach a final pressure of 20 bar. Then, 8 g of 1,4-diiodoperfluorobutane (C₄F₈I₂) as chain transfer agent were introduced, and 1.25 g of ammonium persulfate (APS) as initiator were introduced. Pressure was maintained at a set-point of 20 bar by continuous feeding of a gaseous mixture of vinylidene fluoride (VDF) (78.5% moles) and hexafluoropropylene (HFP) (21.5% moles) up to a total of 2000 g. Moreover, 0.86 g of CH₂═CH—(CF₂)₆—CH═CH₂, fed in 20 equivalent portions each 5% increase in conversion, were introduced. Then, the reactor was cooled, vented and the latex recovered. The latex was treated with aluminum sulphate, separated from the aqueous phase, washed with demineralized water and dried in a convection oven at 90° C. for 16 hours. Characterization data of the polymer so obtained are reported in Table 1.

### COMPARATIVE EXAMPLE 2: BLOCK COPOLYMER HAVING STRUCTURE PVDF-P(VDF-HFP-TFE)-PVDF (P(VDF-HFP-TFE) VDF: 50% BY MOLES, HFP: 25% BY MOLES, TFE: 25% BY MOLES)

In a 5 liters reactor equipped with a mechanical stirrer operating at 630 rpm, 3.5 l of demineralized water and 36 ml of a microemulsion, previously obtained by mixing 7.9 ml of a perfluoropolyoxyalkylene having acidic end groups of formula CF₂ClO(CF₂—CF(CF₃)O)ₙ(CF₂O)ₘCF₂COOH, wherein n/m=10, having an average molecular weight of 600, 5.1 ml of a 30% v/v NH₄OH aqueous solution, 18.0 ml of demineralized water and 5.0 ml of GALDEN® D02 perfluoropolyether of formula CF₃O(CF₂CF(CF₃)O)ₙ(CF₂O)ₘCF₃, wherein n/m=20, having an average molecular weight of 450, were introduced.

The reactor was heated and maintained at a set-point temperature of 80° C.; a mixture of vinylidene fluoride (VDF) (25.5% by moles), hexafluoropropylene (HFP) (58.5% by moles) and tetrafluoroethilene (16.0% by moles) was then added to reach a final pressure of 25 bar. Then, 6 g of 1,4-diiodoperfluorobutane (C₄F₈I₂) as chain transfer agent were introduced, and 0.112 g of ammonium persulfate (APS) as initiator were introduced. Pressure was maintained at a set-point of 25 bar by continuous feeding of a gaseous mixture of vinylidene fluoride (VDF) (50.0% by moles), hexafluoropropyene (HFP) (26.0% by moles) and tetrafluoroethylene (24.0% by moles) up to a total of 1500 g. Moreover, 3 g of CH₂═CH—(CF₂)₆—CH═CH₂, fed in 20 equivalent portions each 5% increase in conversion, were introduced.

Once 1500 g of monomer mixture were fed to the reactor, the reaction was discontinued by cooling the reactor to room temperature. The residual pressure was then discharged and the temperature brought to 80° C. VDF was then fed into the autoclave up to a pressure of 20 bar, and 0.05 g of ammonium persulfate (APS) as initiator were introduced. Pressure was maintained at a set-point of 20 bar by continuous feeding of VDF up to a total of 375 g. Then, the reactor was cooled, vented and the latex recovered. The latex was treated with aluminum sulphate, separated from the aqueous phase, washed with demineralized water and dried in a convection oven at 90° C. for 16 hours. Characterization data of the polymer so obtained are reported in Table 1.

### COMPARATIVE EXAMPLE 3: P(VDF-HFP-TFE) FLUOROELASTOMER (VDF: 50% BY MOLES, HFP: 25% BY MOLES, TFE: 25% BY MOLES)

In a 5 liters reactor equipped with a mechanical stirrer operating at 630 rpm, 3.5 l of demineralized water and 36 ml of a microemulsion, previously obtained by mixing 7.9 ml of a perfluoropolyoxyalkylene having acidic end groups of formula CF₂ClO(CF₂—CF(CF₃)O)ₙ(CF₂O)ₘCF₂COOH, wherein n/m=10, having an average molecular weight of 600, 5.1 ml of a 30% v/v NH₄OH aqueous solution, 18.0 ml of demineralized water and 5.0 ml of GALDEN® D02 perfluoropolyether of formula CF₃O(CF₂CF(CF₃)O)ₙ(CF₂O)ₘCF₃, wherein n/m=20, having an average molecular weight of 450, were introduced.

The reactor was heated and maintained at a set-point temperature of 80° C.; a mixture of vinylidene fluoride (VDF) (25.5% by moles), hexafluoropropylene (HFP) (58.5% by moles) and tetrafluoroethylene (16.0% by moles) was then added to reach a final pressure of 25 bar. Then, 6 g of 1,4-diiodoperfluorobutane (C₄F₈I₂) as chain transfer agent were introduced, and 0.112 g of ammonium persulfate (APS) as initiator were introduced. Pressure was maintained at a set-point of 25 bar by continuous feeding of a gaseous mixture of vinylidene fluoride (VDF) (50.0% by moles), hexafluoropropylene (HFP) (26.0% moles) and tetrafluoroethylene (24.0% by moles) up to a total of 1500 g. Moreover, 3 g of CH₂═CH—(CF₂)₆—CH═CH₂, fed in 20 equivalent portions each 5% increase in conversion, were introduced.

Then, the reactor was cooled, vented and the latex recovered. The latex was treated with aluminum sulphate, separated from the aqueous phase, washed with demineralized water and dried in a convection oven at 90° C. for 16 hours. Characterization data of the polymer so obtained are reported in Table 1.

As shown in Table 1 here below, the fluorinated thermoplastic elastomer of the present invention as notably embodied by the block copolymer of Example 1 according to the invention, wherein the elastomeric block is substantially free from recurring units derived from tetrafluoroethylene, unexpectedly has a glass transition temperature lower than the glass transition temperature of the corresponding fluoroelastomer as notably embodied by the fluoroelastomer of Comparative Example 1.

Also, as shown in Table 1 here below, the fluorinated thermoplastic elastomer of the present invention as notably embodied by the block copolymer of Example 1 according to the invention, wherein the elastomeric block is substantially free from recurring units derived from tetrafluoroethylene, unexpectedly has a glass transition temperature lower than the glass transition temperature of the block copolymer of Comparative Example 2, wherein the elastomeric block further comprises recurring units derived from tetrafluoroethylene.

On the other side, the block copolymer of Comparative Example 2, wherein the elastomeric block further comprises recurring units derived from tetrafluoroethylene, has a glass transition temperature higher than the glass transition temperature of the corresponding fluoroelastomer of Comparative Example 3.

TABLE 1

| DSC | | Ex. 1 | | C. Ex. 1 | C. Ex. 2 | | C. Ex. 3 |
|---|---|---|---|---|---|---|---|
| T_{g} | [° C.] | −21.5 | | −18.0 | −9.0 | | −10.6 |
| Tₘ | [° C.] | 162.5 | | — | 162.4 | | — |
| ΔHₘ | [J/g] | 11.6 | | — | 15.9 | | — |
| | | soft | hard | | soft | hard | |
| Composition - NMR | | (A) | (B) | | (A) | (B) | |
| VDF | [% mol] | 78.5 | 100 | 78.5 | 50 | 100 | 50 |
| HFP | [% mol] | 21.5 | — | 21.5 | 25 | — | 25 |
| TFE | [% mol] | — | — | — | 25 | — | 25 |

In view of the above, it has been surprisingly found that the fluorinated thermoplastic elastomer of the present invention, wherein the elastomeric block is substantially free from recurring units derived from tetrafluoroethylene, exhibits outstanding performances such as outstanding mechanical performances over a wide range of temperatures up to low temperatures to be suitably used in various applications such as, for instance, low temperature applications.

1. A fluorinated thermoplastic elastomer comprising:
at least one block (A) consisting of at least one elastomeric fluoropolymer substantially free from recurring units derived from tetrafluoroethylene (TFE), and
at least one block (B) consisting of at least one thermoplastic fluoropolymer comprising:
recurring units derived from vinylidene fluoride (VDF), and
optionally, recurring units derived from at least one fluorinated monomer different from VDF.

2. The fluorinated thermoplastic elastomer according to claim 1, said fluorinated thermoplastic elastomer comprising one or more repeating structures of type B-A-B.

3. The fluorinated thermoplastic elastomer according to claim 1, wherein the elastomeric fluoropolymer of the block (A) has a heat of fusion of less than 5 J/g, measured according to ASTM D3418-08.

4. The fluorinated thermoplastic elastomer according to claim 1, wherein the elastomeric fluoropolymer of the block (A) consists of:
recurring units derived from vinylidene fluoride (VDF),
recurring units derived from at least one fluorinated monomer different from VDF and tetrafluoroethylene (TFE), and
optionally, recurring units derived from at least one hydrogenated monomer.

5. The fluorinated thermoplastic elastomer according to claim 1, wherein the elastomeric fluoropolymer of the block (A) consists of:
from 45% to 90% by moles of recurring units derived from vinylidene fluoride (VDF),
from 5% to 50% by moles of recurring units derived from at least one fluorinated monomer different from VDF and tetrafluoroethylene (TFE), and
optionally, up to 30% by moles of recurring units derived from at least one hydrogenated monomer.

6. The fluorinated thermoplastic elastomer according to claim 1, wherein the thermoplastic fluoropolymer of the block (B) has a heat of fusion of from 10 J/g to 90 J/g, as measured according to ASTM D3418-08.

7. The fluorinated thermoplastic elastomer according to claim 1, wherein the thermoplastic fluoropolymer of the block (B) comprises:
recurring units derived from vinylidene fluoride (VDF), and
optionally, from 0.1% to 10% by moles of recurring units derived from at least one fluorinated monomer different from VDF.

8. The fluorinated thermoplastic elastomer according to claim 1, wherein the thermoplastic fluoropolymer of the block (B) further comprises recurring units derived from at least one hydrogenated monomer.

9. The fluorinated thermoplastic elastomer according to claim 1, wherein the weight ratio between blocks (A) and blocks (B) is comprised between 5:95 and 95:5.

10. A process for the manufacture of the fluorinated thermoplastic elastomer according to claim 1, said process comprising the following sequential steps:
(a) polymerizing at least one fluorinated monomer different from tetrafluoroethylene (TFE) and, optionally, at least one hydrogenated monomer, in the presence of a radical initiator and of an iodinated chain transfer agent, thereby providing a pre-polymer consisting of at least one block (A) containing one or more iodinated end groups; and
(b) polymerizing vinylidene fluoride (VDF), optionally at least one fluorinated monomer different from VDF, and optionally at least one hydrogenated monomer, in the presence of a radical initiator and of the pre-polymer provided in step (a), thereby providing at least one block (B) grafted on said pre-polymer by means of the iodinated end groups.

11. A composition (C) comprising:
at least one fluorinated thermoplastic elastomer according to claim 1, and
optionally, one or more additives.

12. An article comprising the composition (C) according to claim 11.

13. (canceled)

14. A method for manufacturing an article, the method comprising using the composition (C) according to claim 11 as a processing aid.

15. A process for the manufacture of the article according to claim 12, said process comprising processing a composition comprising at least one polymer, in the presence of a composition (C), using a melt-processing technique selected from compression moulding, injection moulding and extrusion moulding,
wherein composition (C) comprises:
at least one fluorinated thermoplastic elastomer comprising:
at least one block (A) consisting of at least one elastomeric fluoropolymer substantially free from recurring units derived from tetrafluoroethylene PTFE), and
at least one block (B) consisting of at least one thermoplastic fluoropolymer comprising:
recurring units derived from vinylidene fluoride (VDF), and
optionally, recurring units derived from at least one fluorinated monomer different from VDF, and
optionally, one or more additives.

16. The fluorinated thermoplastic elastomer according to claim 4, wherein the elastomeric fluoropolymer of the block (A) has a heat of fusion of less than 3 J/g, as measured according to ASTM D3418-08.

17. The fluorinated thermoplastic elastomer according to claim 6, wherein the thermoplastic fluoropolymer of the block (B) has a heat of fusion of from 30 J/g to 60 J/g, as measured according to ASTM D3418-08.

18. The fluorinated thermoplastic elastomer according to claim 9, wherein the weight ratio between blocks (A) and blocks (B) is typically comprised between 20:80 and 80:20.

19. The fluorinated thermoplastic elastomer according to claim 1, wherein:
the elastomeric fluoropolymer of the block (A) consists of:
recurring units derived from vinylidene fluoride (VDF),
recurring units derived from at least one fluorinated monomer different from VDF and tetrafluoroethylene (TFE), and
optionally, recurring units derived from at least one hydrogenated monomer; and
the thermoplastic fluoropolymer of the block (B) comprises:
recurring units derived from vinylidene fluoride (VDF), and
optionally, from 0.1% to 10% by moles of recurring units derived from at least one fluorinated monomer different from VDF.

20. The fluorinated thermoplastic elastomer according to claim 19, wherein the elastomeric fluoropolymer of the block (A) consists of:
from 45% to 90% by moles of recurring units derived from vinylidene fluoride (VDF),
from 5% to 50% by moles of recurring units derived from at least one fluorinated monomer different from VDF and tetrafluoroethylene (TFE), and
optionally, up to 30% by moles of recurring units derived from at least one hydrogenated monomer.
